(19) United States
(12) Patent Application Publication
(10) Pub. No.: US 2011/0283557 A1
(43) Pub. Date: Nov. 24, 2011

(54) MODULATED AIR FLOW CLOTHES DRYER AND METHOD

(75) Inventor: Russell H. Poy, New Orleans, LA (US)

(73) Assignee: PELLERIN MILNOR CORPORATION, Kenner, LA (US)

(21) Appl. No.: 12/834,480

(22) Filed: Jul. 12, 2010

Related U.S. Application Data
(60) Provisional application No. 61/224,986, filed on Jul. 13, 2009.

(51) Int. Cl. F26B 3/02; F26B 21/06; D06F 58/04

(52) U.S. Cl. 34/499; 34/132; 34/559

(57) ABSTRACT

A textile articles dryer provides a chassis or housing supporting a rotating drum. A main air inlet enables air to enter the rotating drum. A main air outlet enables air to exit the rotating drum. A vacuum blower pulls a main airflow stream in between the main air inlet and the main air outlet. A heater is in communication with the main airflow stream for heating the air in the main flow stream. A controller maintains a generally constant vacuum in the rotating drum by lowering blower speed responsive to a blockage or near blockage of the main air outlet by one or more textile articles that are being dried.

### CROSS-REFERENCE TO RELATED APPLICATIONS

Priority of U.S. Provisional Patent Application Ser. No. 61/224,986, filed 13 Jul. 2009, incorporated herein by reference, is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to clothes dryers and a method of operating a clothes dryer. More particularly, the present invention relates to an improved method and apparatus for drying clothes wherein a suction blower pulls air from a dryer chamber to create a vacuum within the dryer chamber, the vacuum generated by the suction blower being controlled (e.g., computer, controller) in response to the rate of change of increasing or decreasing vacuum within the chamber. The method further includes the adjusting of the speed of the blower to maintain a constant vacuum such as in cases of a rapidly increasing vacuum as occurs when clothes or linens block the air flow. A lowering of the speed of the suction blower thus automatically results when such a blockage or near blockage occurs.

2. General Background of the Invention Textile clothes dryers create a vacuum inside the drying chamber of the clothes dryer. This vacuum is created by a suction blower that is mounted on a main air outlet. Heated air enters the vacuum chamber via a main air inlet. A heater can be placed in line with the main air inlet generating heated air. The very nature of linen (or other textiles or clothes) rotating inside of a drum of a dryer often blocks the air flow through the dryer. This condition can result in linen or textile damage and a waste of energy.

### BRIEF SUMMARY OF THE INVENTION

The present invention provides an improved method of operating a clothes dryer. The present invention provides an improved modulated air flow clothes dryer apparatus.

The present invention employs a suction blower that is mounted on a main air outlet of a dryer housing. A main air inlet enables air to flow into a drying chamber. A heater heats air that travels into the drying chamber via a main air inlet. The drying chamber can be a rotating drum. The suction blower rotation speed is controllable. For example, a frequency inverter (commercially available) can be used to control the rotation speed of the suction blower.

A pressure transducer (commercially available) is mounted in communication with the drying chamber. The pressure transducer measures the vacuum inside the dryer housing. The transducer enables the rate of change of increasing or decreasing vacuum to be measured.

A software algorithm can be used to interpret the rate of change of increasing or decreasing vacuum. This software algorithm can also adjust the speed of a blower to maintain a constant or nearly constant vacuum.

In a case where the linen blocks the air flow, the vacuum in the dryer housing rapidly increases. Responsive to this rapid increase in vacuum, the speed of the suction blower is reduced. The speed reduction of the suction blower lowers the vacuum, eliminating the blockage. A control feedback loop can be used to reduce the rotation speed of the blower and eliminate the blockage.

By measuring the rate of change of the vacuum, a software algorithm can predict when linen is about to block the air flow thereby eliminating the condition before it occurs. By preventing the linen from beginning to block the air flow, the linen is maintained in an optimum suspension in the heated air stream within the chamber.

The present invention saves energy because no heated air is wasted. Such an energy waste can occur when blockage retards the main air flow stream.

Energy is further saved because drying time is shortened by keeping the clothes or linen in the optimum suspension in the heated air stream thereby efficiently using the heated air.

Energy is also saved by never allowing a blockage of the air stream. Thus, drying time is shortened.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawing, wherein like reference numerals denote like elements and wherein:

FIG. 1 is a schematic diagram that shows a preferred embodiment of the apparatus of the present invention.

### DETAILED DESCRIPTION OF THE INVENTION

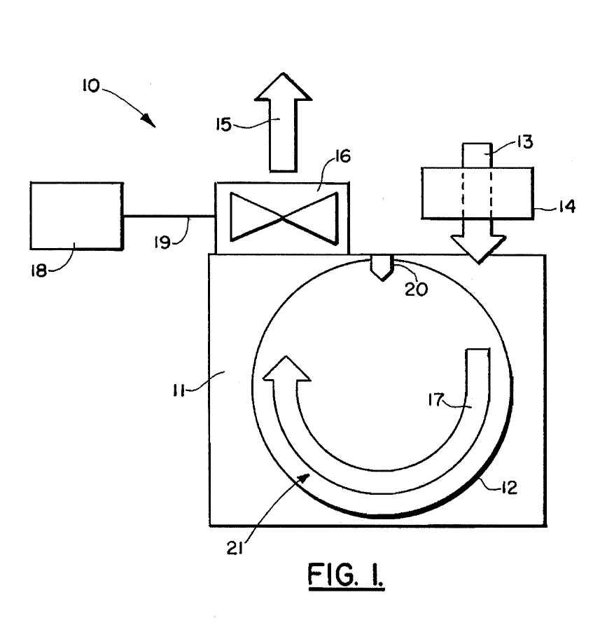

FIG. 1 shows a preferred embodiment of the apparatus of the present invention, designated generally by the numeral 10. Clothes dryer apparatus 10 provides a dryer housing, frame, or chassis 11. The dryer housing, frame, or chassis 11 supports a drum 12 that can be a rotating drum. Dryer housing 11 provides an opening that can be closed with a door for adding previously washed, wetted textile articles such as clothes or linen to a drum 12 so that those wetted articles can then be dried. Textiles as used herein refers to any washable fabric article.

A main air inlet 13 enables air to enter a drying chamber 21 within drum 12. Heater 14 can be placed next to or upon frame 11 at main air inlet 13. In this fashion, heat transfer from heater 14 can be used to heat air that enters dryer chamber 21 via main air inlet 13.

A main air outlet 15 is provided for exhausting air from drying chamber 21. Suction blower 16 is placed in a position next to or attached to frame 11 as shown in FIG. 1. Suction blower 16 can be a power blower that pulls air from drying chamber 21. Thus, a path for airflow is created between main air inlet 13 and main air outlet 15 when suction blower 16 is activated. Arrow 17 in FIG. 1 schematically illustrates this air flow path inside the clothes dryer apparatus 10 or dryer housing 11.

A pressure transducer 20 is mounted to frame or dryer housing or chassis 11. The pressure transducer enables pressure readings to be taken at intervals or continuously. These pressure readings enable a frequency inverter 18 to detect pressure changes within drying chamber 21. A control line 19 extends between frequency inverter 18 and suction blower 16. The suction blower 16 rotation speed is thus controlled using frequency inverter 18. Pressure transducer 20 measures the vacuum level inside dryer housing 11. A software algorithm interprets the rate of change of increasing or decreasing vacuum. The software algorithm automatically adjusts the speed of the blower to maintain a constant vacuum.

In a case wherein the textile articles (or article) block the airflow at main air outlet 15, the vacuum in the dryer housing 11 rapidly increases. A control feedback loop then reduces the rotation speed of the suction blower 16, eliminating the blockage. By measuring the rate of change of the vacuum, the software algorithm is able to predict when the textiles are about to block the airflow at main air outlet 15. The software algorithm quickly lowers the rotation of the suction blower to eliminate the possibility of blockage before blockage occurs. The software algorithm measures the rate of change of the vacuum and predicts when the linen or textiles are about to block the airflow, thereby eliminating a blockage condition. By keeping the textiles from even beginning to block the airflow at main air outlet 15, the textiles are maintained in an optimum suspension in a heated airstream path that connects main air inlet 13 to main air outlet 15, the path indicated schematically by arrow 17 in FIG. 1.

With the present invention, energy is saved because no heated air is wasted from blockage in the main airstream between main air inlet 13 and main air outlet 15.

Energy is saved because drying time is shortened by keeping the textiles in an optimum suspension within the heated air stream that extends between main air inlet 13 and main air outlet 15, thereby efficiently using the heated air.

Energy is saved because drying time is shortened by never allowing a blockage of the airstream or air flow path.

The following is a list of parts and materials suitable for use in the present invention.

PARTS LIST

| Part Number | Description |
|---|---|
| 10 | clothes dryer apparatus |
| 11 | dryer housing/frame/chassis |
| 12 | drum |
| 13 | main air inlet |
| 14 | heater |
| 15 | main air outlet |
| 16 | suction blower |
| 17 | arrow |
| 18 | frequency inverter |
| 19 | control line |
| 20 | pressure transducer |
| 21 | drying chamber |

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the following claims.

1. A textile articles dryer, comprising;
a) a housing;
b) a rotating drum supported by the housing, the drum defining a drying chamber;
c) a main air inlet enabling air to enter the rotating drum;
d) a main air outlet enabling air to exit the rotating drum;
e) a vacuum blower in communication with the drying chamber that pulls a main air flow stream connecting the main air inlet and main air outlet;
f) a heater in communication with the main air flow stream that heats the air in the main air flow stream; and
g) a controller that maintains a generally constant vacuum in the drying chamber by lowering blower speed responsive to a blockage or near blockage of the main air outlet by one or more textile articles.

2. The textile articles dryer of claim 1 wherein the controller includes a frequency inverter.

3. The textile articles dryer of claim 1 wherein the controller includes a pressure transducer that monitors vacuum in the chamber.

4. The textile articles dryer of claim 1 wherein the controller lowers speed of the blower responsive to a vacuum increase and before a blockage occurs.

5. The textile articles dryer of claim 1 wherein the controller includes a control feedback loop that reduces blower speed.

6. The textile articles dryer of claim 1 wherein the controller measures the rate of change of the vacuum to enable prediction of blockage just before blockage occurs.

7. The textile articles dryer of claim 1 wherein the heater is positioned next to the main air inlet.

8. The textile articles dryer of claim 1 wherein blockage of the main air outlet by textile articles is prevented by the controller by lowering blower speed immediately prior to a potential blockage, the potential blockage characterized by a rapid increase in vacuum.

9. The textile articles dryer of claim 1 wherein the controller includes a computer.

10. A method of drying textiles, comprising the steps of:
a) providing a housing having a drying chamber that includes a rotating drum supported by the housing, a main air inlet enabling air to enter the rotating drum, a main air outlet enabling air to exit the rotating drum;
b) pulling a vacuum on a main air flow stream that connects the main air inlet and main air outlet;
c) heating the air in the main air flow stream; and
d) maintaining a generally constant vacuum in the drying chamber by lowering blower speed responsive to a blockage condition or near blockage condition at the main air outlet by one or more textile articles.

11. The method of claim 10 wherein in step “d” a frequency inverter is used to control the vacuum blower speed.

12. The method of claim 10 wherein in step “d” a pressure transducer monitors vacuum in the chamber.

13. The method of claim 10 wherein in step “d” a controller lowers speed of the blower responsive to a vacuum increase and before a blockage occurs.

14. The method dryer of claim 13 wherein the controller includes a control feedback loop and further comprising the control feedback loop reducing blower speed.

15. The method of claim 10 wherein in step “d” a controller measures the rate of change of the vacuum to enable prediction of blockage just before blockage occurs.

16. The method of claim 10 wherein in step “c” a heater positioned next to the main air inlet heats air at the main air inlet.

17. The method of claim 10 wherein step “d” includes preventing blockage of the main air outlet by lowering blower speed immediately prior to a potential blockage, the potential blockage characterized by a rapid increase in vacuum.
